(19) United States
(12) Patent Application Publication
(10) Pub. No.: US 2004/0267613 A1
(43) Pub. Date: Dec. 30, 2004

(54) System and method for presenting personalized content on electronic commerce web pages

(75) Inventors: Laura M.L. Chan, Toronto (CA); Carsten E. Mytroen, Markham (CA); Tack Tong, Scarborough (CA)

Correspondence Address: John D. Flynn, IBM Corporation, Dept. T81/Bldg. 503, PO Box 12195, Research Triangle Park, NC, 27709, US

(73) Assignee: International Business Machines Corporation, Armonk, NY (US)

(21) Appl. No.: 10/753,204

(22) Filed: Jan. 7, 2004

(30) Foreign Application Priority Data
Jun. 25, 2003 (CA) 2,433,375

(51) Int. Cl. G06F 17/60

(52) U.S. Cl. 705/14; 705/26

(57) ABSTRACT

A web-based electronic commerce system provides users with marketing content for certain items. The system utilizes personalization technology to provide information usable to generate recommendations to users. The presentation of recommendations to a user is carried out by use of a product exploration or guided search technology. A personalized web page contains links to one or more initial product exploration or guided search web pages, or both. The initial product exploration or guided search web pages contain links to other web pages defined using the respective technologies and the personalization information available regarding the user.

### CROSS-REFERENCE TO RELATED APPLICATION

This application claims priority under 35 U.S.C. § 119 based upon an application filed in Canada (CA) on Jun. 25, 2003 having a Canadian application number 2,433,375 entitled “SYSTEM AND METHOD FOR PRESENTING PERSONALIZED CONTENT ON ELECTRONIC COMMERCE WEB PAGES,” which is incorporated herein by reference.

### TECHNICAL FIELD

The present invention relates generally to web-based computing systems, and more specifically to a system and method for presenting content on web pages in electronic commerce systems.

### BACKGROUND INFORMATION

Web-based electronic commerce (e-commerce) computer systems are used to provide marketing content to users or customers. Such marketing content may be presented by way of banner advertisements, catalogue entries, images, or text entries, all appearing on web pages. It is common for computer systems that provide such marketing content to also include functionality to personalize the marketing content for individual users (consumers) or for specific groups of users. Different computer systems may use a variety of personalization technologies such as rule-based systems, collaborative filtering, neural networks, data mining, and other artificial intelligence approaches to select certain marketing content elements for display to users accessing web-pages provided by the systems. Such prior art systems provide marketing content elements to users, which elements include personalized content that is tailored for the users.

Previous patents disclose different approaches to personalization. One approach uses collaborative filtering technology to personalize marketing content elements presented to a customer or user. Automated collaborative filtering systems have been described as systems which predict a customer's affinity for items or information by connecting recorded customer attributes with those of community of customers and sharing affinity ratings between like-minded customers (see the Association of Computing Machinery paper “Explaining Collaborative Filtering Recommendations”, Jonathan L. Herlocker, et al., CSCW'00, Dec. 2-6, 2000, Philadelphia, Pa., U.S.A.).

Different issued patents describe systems based on collaborative filtering. For example, U.S. Pat. No. 5,704,017 (Heckerman et al., Dec. 30, 1997), U.S. Pat. No. 6,041,311 (Chislenko et al., Mar. 21, 2000), U.S. Pat. No. 6,064,980 (Jacobi et al., May 16, 2000), U.S. Pat. No. 6,092,049 (Chislenko et al., Jul. 18, 2000), U.S. Pat. No. 6,266,649 (Linden et al., Jul. 24, 2001), Patent Cooperation Treaty (PCT) application WO 98/33135 (Chislenko et al., Jul. 30, 1998), which all include descriptions of systems that implement collaborative filtering. Other recommendation systems may use segmentation of user profiles or a grouping of users based on textual descriptions of products browsed or purchased (see, for example, PCT application WO 01/33410 A2, (Cooper, et al., May 10, 2001) and U.S. Pat. No. 6,356,879 (Aggarwal et al., Mar. 12, 2002), respectively).

The types of approaches referred to above typically provide personalized marketing content elements which are delivered to a user in a way that may include summary information about a product or service with links to web pages having detailed product information on those pages describing the product or service. Alternatively, a link may be provided to web pages that display product or service information within a defined category.

In these types of systems, the delivery of the personalized selections is such that once a personalized web page with links to web pages for products (or services) is provided, navigation is left to the user. The user (consumer) is often faced with a cumbersome process when the user seeks to browse web pages for recommended products or for products within a recommended category or categories. Typically, a consumer will use a browser to follow a link from the personalized web page to a separate web page with detailed information about a first product. Before accessing other pages having information about other products the consumer must use the browser to again display the personalized web page. The user will only then be able to follow other links to reach web pages with detailed information about other products. This back and forth navigation is not convenient for the consumer seeking to access product or service information made available by the web-based e-commerce system. Such an approach also requires the consumer to remember the details of web pages viewed initially to make comparisons with products described on web pages viewed later in the process.

Another drawback for the user is that the web-based system providing the personalized web page will present the product web page links in a manner determined by the personalization algorithms of the e-commerce system. Such presentation may result in less-preferred links being given a higher priority than links that the consumer is more interested in. Alternatively, or in the same process, the personalization system may take steps to make the presentation of recommendations manageable where the potential set of recommendations is large. The presentation of recommendations by the personalization system may, in this second case, also include the pruning of recommendations (links) based on a method that is arbitrary or based on heuristics implemented in the personalization system. Such pruning may result in only a small subset of the potential links being displayed for the user.

For these reasons, the consumer may be presented with a number of links to product information in which only a subset of those links relate to web pages that the consumer is actually interested in viewing, or may be presented with only a subset of the links that the consumer potentially is interested in. In the first case, the consumer will typically need to follow the different links presented so as to view the details of the products to determine whether the products are of interest or not. A potentially large number of web pages with undesirable products may be accessed by the user before reaching those web pages relating to products of interest. In the second case, the consumer will be potentially not be provided with links of interest due to the pruning that has been carried out by the personalization system.

It is therefore desirable to provide a web-based system for presenting or delivering marketing content to a user or consumer in which personalized information is delivered and in which the marketing content delivery to the user or consumer facilitates the efficient display of web pages of interest.

### SUMMARY

Accordingly, the present invention provides a system and method for improved presentation of content to a user using personalization and product exploration metaphor technology.

According to another aspect of the present invention, there is provided a computer program product for providing web-based electronic commerce personalized marketing content to a user, the computer program product including a computer usable medium having computer readable program code embodied in the medium, and including computer readable program code for defining a personalized web page including one or more links to initial product exploration or guided search web pages, the links being based on personalization information for the user, computer readable program code for defining the one or more initial product exploration or guided search web pages, each initial product exploration or guided search web page being determined based on personalization information for the user, each initial product exploration web page including an entry point to a set of exploration web pages defined according to product exploration metaphor technology and the set of the exploration web pages being defined with reference to personalization information for the user, and each initial guided search web page including an entry point to a set of guided search web pages defined according to guided search technology and the set of the guided search web pages being defined with reference to personalization information for the user, and computer readable program code for providing the defined web pages to the user for display.

According to another aspect of the present invention, there is provided the above computer program product in which the personalization information for the user includes a set of item attributes defined by a personalization system.

According to another aspect of the present invention, there is provided the above computer program product in which each initial product exploration web page includes a link to a result page including a result list having an item attribute table in which attributes of a set of items are grouped to permit comparison by a user.

According to another aspect of the present invention, there is provided the above computer program product in which the set of guided search web pages includes web pages corresponding to a subset of potential guided search nodes in a guided search tree, the subset being defined with reference to the personalization information for the user.

According to another aspect of the present invention, there is provided a web-based electronic commerce system for providing personalized marketing content to a user, the system including means for defining a personalized web page including one or more links to initial product exploration or guided search web pages, the links being based on personalization information for the user, means for defining the one or more initial product exploration or guided search web pages, each initial product exploration or guided search web page being determined based on personalization information for the user, each initial product exploration web page including an entry point to a set of exploration web pages defined according to product exploration metaphor technology and the set of the exploration web pages being defined with reference to personalization information for the user, and each initial guided search web page including an entry point to a set of guided search web pages defined according to guided search technology and the set of the guided search web pages being defined with reference to personalization information for the user, and means for providing the defined web pages to the user for display.

According to another aspect of the present invention, there is provided, in a web-based electronic commerce system for providing personalized marketing content to a user and in which web pages are provided to the user, a personalized web page including one or more links to a set of initial product exploration web pages, the links being based on personalization information for the user, each initial product exploration web page being determined based on personalization information for the user and including an entry point to a set of exploration web pages defined according to product exploration metaphor technology, and the set of the exploration web pages being defined with reference to personalization information for the user.

According to another aspect of the present invention, there is provided, in a web-based electronic commerce system for providing personalized marketing content to a user and in which web pages are provided to the user, a personalized web page including one or more links to a set of initial guided search web pages, the links being based on personalization information for the user, each initial guided search web page being determined based on personalization information for the user and including an entry point to a set of guided search web pages defined according to guided search technology, and the set of the guided search web pages being defined with reference to personalization information for the user.

According to another aspect of the present invention, there is provided, a computer-implemented method for providing web-based electronic commerce personalized marketing content to a user, the method including the steps of defining a personalized web page including one or more links to initial product exploration or guided search web pages, the links being based on personalization information for the user, defining the one or more initial product exploration or guided search web pages, each initial product exploration or guided search web page being determined based on personalization information for the user, each initial product exploration web page including an entry point to a set of exploration web pages defined according to product exploration metaphor technology and the set of the exploration web pages being defined with reference to personalization information for the user, and each initial guided search web page including an entry point to a set of guided search web pages defined according to guided search technology and the set of the guided search web pages being defined with reference to personalization information for the user, and providing the defined web pages to the user for display in response to requests from the user.

According to another aspect of the present invention, there is provided a computer program product including a computer-readable signal-bearing medium, the medium including means for accomplishing the above method and in which the medium is a recordable data storage medium or a modulated carrier signal. In the latter case, the signal may be a transmission over a network and the network may be the Internet.

The present invention thus improves the presentation of personalized web pages to a user by providing links defined by personalization where the pages that are linked to are defined based on personalization technology and the web pages linked to implement product exploration and/or guided search technology so as to enhance the opportunity for the user to tailor information subsequently to be made available to the user on the web pages presented.

### BRIEF DESCRIPTION OF THE DRAWINGS

The present invention is illustrated by way of example and is not limited by the figures of the accompanying drawings in which:

FIG. 1 is a block diagram illustrating example web pages accessible in accordance with a first or a second embodiment of the invention;

FIG. 2 is a block diagram illustrating example web pages accessible in accordance with an embodiment of the invention;

FIG. 3 is a block diagram illustrating an example of a personalization system in accordance with an embodiment of the invention;

FIG. 4 is a flowchart showing the high level steps in the method of an embodiment of the invention;

FIG. 5 is a tree diagram illustrating the structure of an example implementation of a guided search system used in an embodiment of the invention; and

FIG. 6 is a block diagram of a data processing system configurable to be used by any embodiment of the present invention, including any of the systems described with respect to FIGS. 1-5.

### DETAILED DESCRIPTION

An embodiment of the present invention may be implemented using a web-based e-commerce system. The embodiment provides web pages to users who run commercially available web browsers. Such browsers permit users to request and display web pages made available by a web server. In the description of the embodiments, reference is made to consumers or customers (users) seeking information about products. It will be understood by those skilled in the art that the e-commerce system of the present invention (and the corresponding method) may be adapted to provide a user with access to other marketing content elements that may be of interest to the user, where the user attributes may be determined and relied on by the system in providing such access and where there are potentially multiple web pages with such marketing content elements that the user may select from.

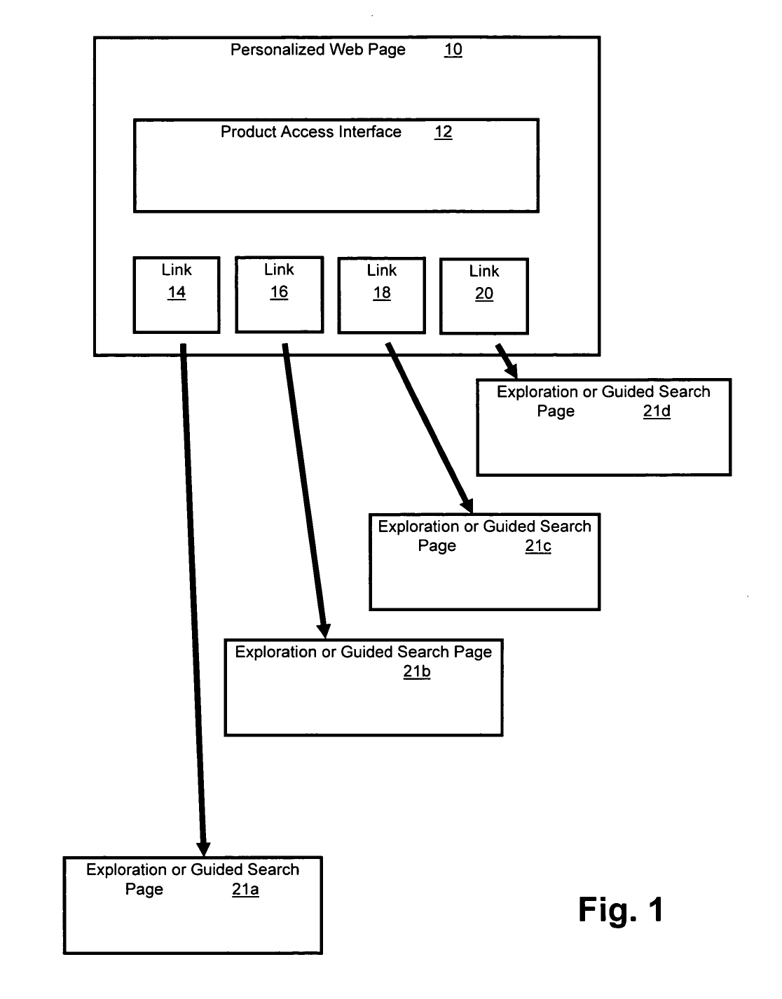

FIG. 1 is a block diagram illustrating schematic representations of example web pages made accessible to a user. The delivery of marketing content elements to a consumer or user is achieved by the user accessing web pages. In FIG. 1, personalized web page 10 accessible to a customer or user is shown having product interface 12 and a set of links 14, 16, 18, and 20. The size of the set of links is variable, depending on the implementation of the system and the attributes of the user accessing the system. Personalized web page 10 is defined using a personalization system that is part of, or accessible to, the e-commerce system. Personalized web page 10 will typically be accessed by a customer as a potentially early step in the process of displaying information relating to a particular type of products.

The content of personalized web page 10, apart from the links referred to above, will depend on the implementation. The content of personalized web page 10 may be the same for all customers (apart from the links) or it may vary for different customers. As an example, one embodiment may be implemented to ultimately display information about a given type of consumer goods or class of industrial equipment. Personalized web page 10 includes product access interface 12 which is defined in a manner suitable for the class of products that the user is seeking to access. For example, as is typical, where an embodiment implements a system for access to a type of consumer goods, product access interface 12 may provide, amongst other tools, a “shopping cart” for the consumer. It will be understood that the design of personalized web page 10 is application specific. The system may be implemented with different personalized web page 10 designs.

In the example shown in FIG. 1, personalized web page 10 includes a set of links 14, 16, 18, and 20. The display information and the URL for each of these links are defined by a personalization system. According to an implementation of the invention, the links 14, 16, 18, and 20 reference a set of exploration or guided search pages 21a, 21b, 21c and 21d, respectively. In one embodiment, links on personalized web page 10 reference exploration pages and in another embodiment, the links reference guided search pages. In both cases, personalized web page 10 is defined to provide the set of links using personalization information relating to a customer or user making use of the electronic commerce system in which the invention is implemented.

The exploration or guided search pages are used to permit the customer to efficiently reach web pages with marketing content of interest. Exploration pages permit the customer to reach the pages of interest by identifying product attributes. Guided search pages permit the customer to reach pages of interest by prompting the customer for answers about the customer's characteristics and preferences. Both the product exploration and guided search pages referenced by personalized web page 10, as described in more detail below, are defined in a manner to make use of personalization information concerning customers using the e-commerce system. The personalization aspect of the system is therefore enhanced through the presentation of recommended links that provide web pages to the user which, in turn, provide content based on either product exploration technology or guided search technology (or a combination).

One embodiment is described below in which an e-commerce system uses product exploration metaphor technology to facilitate the presentation of marketing content to a customer. Another embodiment is also described in which guided search technology is used.

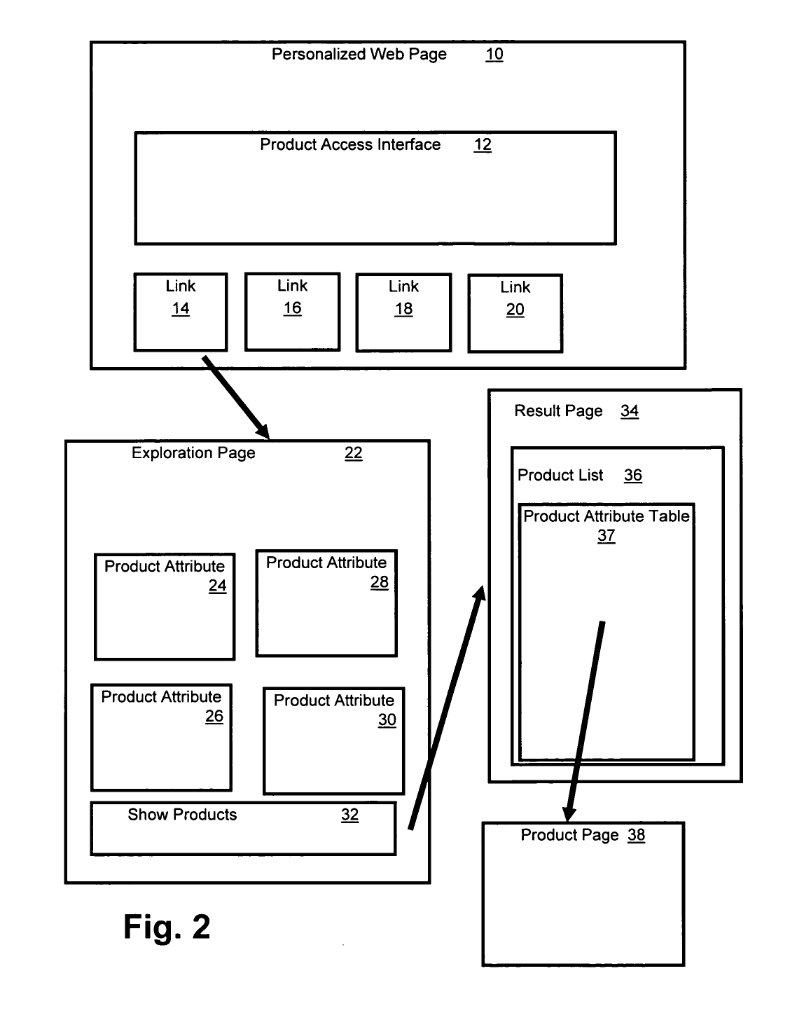

FIG. 2 is a block diagram that relates to a first embodiment. In the example shown in FIG. 2, personalized web page 10 and the set of links 14, 16, 18, and 20 are again shown. In FIG. 2, link 14 is defined to reference exploration page 22. Exploration page 22 is an implementation of product exploration technology.

Exploration page 22 is a web page defined by the system and made available to a customer or customers by a web server (not shown). The page includes interface elements relating to various product attributes, shown schematically in the example of FIG. 2 as product attribute elements 24, 26, 28, and 30. These interface elements may be selected from different known interface technologies including check boxes, sliders, drop down menus and the like. The choice of the interface elements will be made in accordance with understood principles of interface design for the system. The selection and initialization of these product attribute elements is described in more detail below. In the example in FIG. 2, exploration page 22 is the entry point for web pages that are defined to implement a product exploration metaphor (the web pages are defined using product exploration technology).

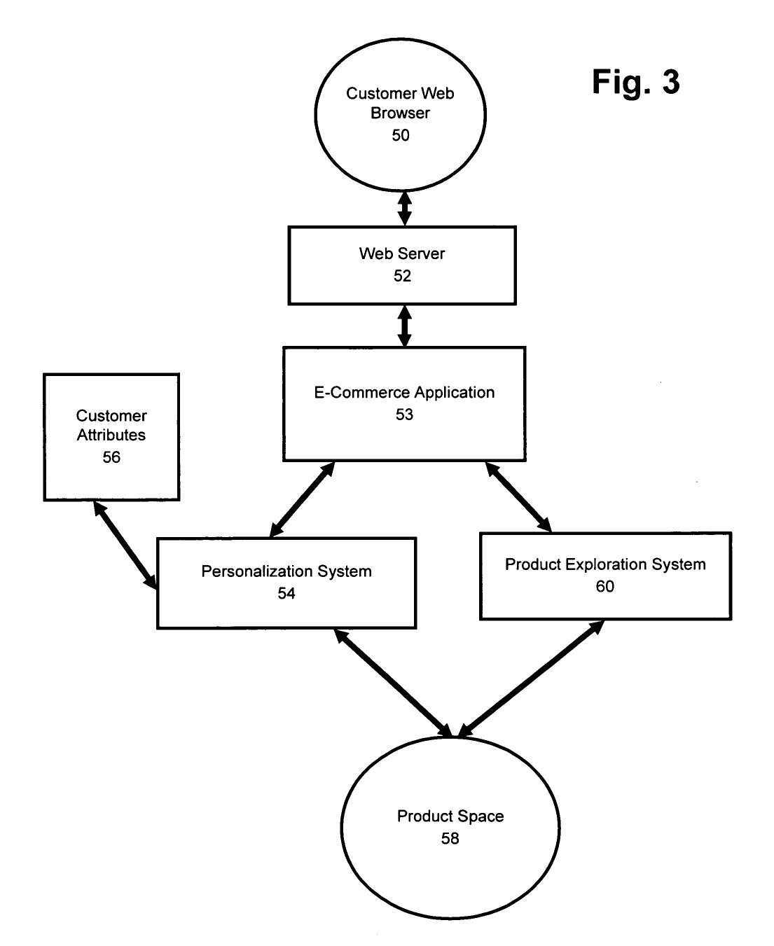

As indicated, links 14, 16, 18, and 20 shown in the example of FIG. 1 are defined using a personalization system. Such systems are known in the art and are commonly utilized in electronic commerce web-based systems. Personalization permits web-based e-commerce systems to select and tailor the web pages that are made available to a customer. FIG. 3 shows, in a block diagram, an example architecture for a personalization system. In FIG. 3 customer web browser 50 is shown with a connection to web server 52. Electronic commerce application 53 and personalization system 54 are shown as separate processes from web server 52 in the example of FIG. 3. It is understood that electronic commerce application 53 and personalization system 54 may be implemented to be resident on web server 52 or may be located on another computing platform.

Using known personalization technologies, personalization system 54 is able to obtain certain attributes relating to the customer using customer web browser 50. These are shown in the example of FIG. 3 as customer attributes 56. The customer using customer web browser 50 may be identifiable based on a log-in procedure for the individual user, based on geographic information about the access path to web server 52, or based on cookies that are generated and stored in association with customer web browser 50 in accessing web server 52. It will also be understood by those skilled in the art that other means of accessing web server 52 other than a full-featured web browser may be used. Personalization system 54 will function if it is able to determine customer attributes 56, relating to a customer who is accessing web server 52.

The attributes shown in FIG. 3 as customer attributes 56 may be dependent on the characteristics of product space 58. In such an implementation, personalization system 54 uses information about product space 58 to determine which aspects of the customer are potentially of interest for the personalization of the information to be presented by electronic commerce application 53 to the customer. It will be understood by those skilled in the art that other approaches to personalization may not make use of information about product space 58.

An example of how product space 58 is used in personalization is where product space 58 relates to sporting goods. In such a case, the leisure activities of the customer will likely be an attribute captured in customer attributes 56. Alternatively, if the example product space relates to pet supplies, previous purchases of pet supplies will be an attribute to be included in customer attributes 56.

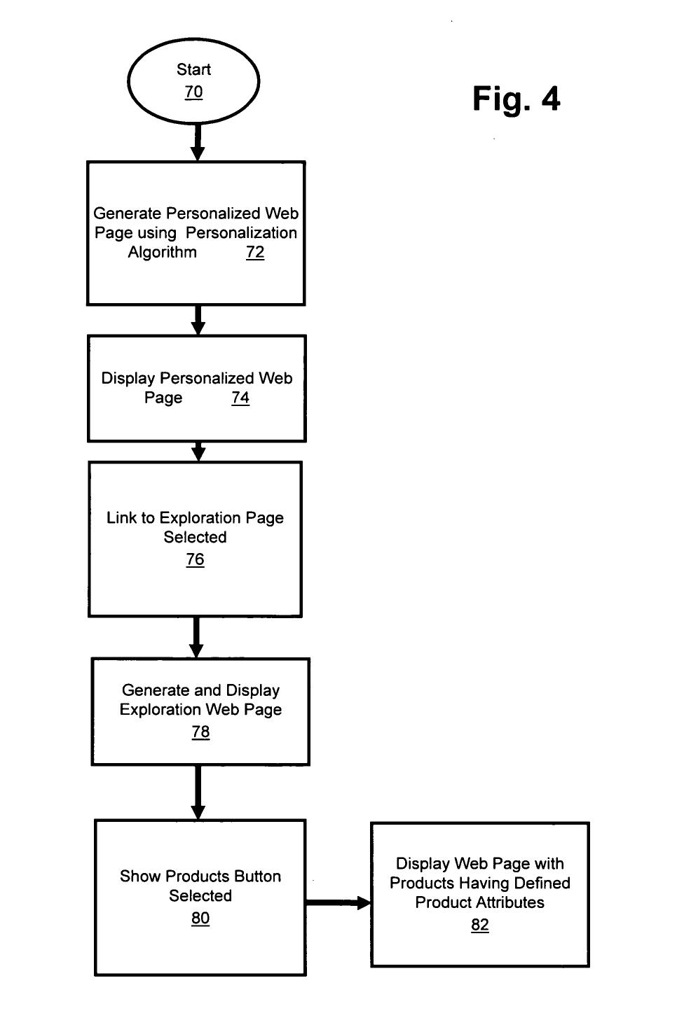

As is discussed below and as may be seen with reference to the flow chart of FIG. 4, personalization system 54 and product exploration system 60 interact in a number of ways: personalization defines the links in personalized page 10, it is used to initialize preset values in exploration page 22, and it may be used to determine the attributes to be displayed in exploration page 22. Exploration system 60 provides the customer with the ability to select amongst potential recommendations otherwise made available by personalization system 54.

As referred to above, personalization system 54 is used to define the links found on personalized web page 10 (see start step 70 and successive steps 72 and 74 in FIG. 4). Customer attributes 56 for a customer accessing the system will be used by personalization system 54 to define the set of links 14, 16, 18, and 20 shown in the example of FIG. 2 (as is referenced in step 72 in FIG. 4). Customer attributes 56 are mapped to product attributes, based on product space 58. For the example in FIG. 2, links 14, 16, 18, and 20 shown on personalized web page 10 reflect product attributes defined by personalization system 54 for the customer.

Product space 58 may be defined very broadly to include different product families. A product family is a set of products to which a defined set of attributes applies. For example, the attribute “size” having potential values “compact”, “mid-size” and “luxury” applies to a product family of vehicles whereas the different attribute “size” having potential values “small”, “medium”, “large” and “extra-large” applies to a product family of clothing.

Personalized links 14, 16, 18, and 20 are defined to point to a set of exploration pages which are, in turn, defined to implement a product exploration metaphor technology. For example, in the example of FIG. 2, when the user (customer) selects link 14 (see step 76 in FIG. 4), exploration page 22 is presented to the user. The content of exploration page 22 is defined to allow the customer to carry out product exploration for a given family of products contained in product space 58. The product exploration metaphor system that is implemented to create exploration pages such as personalization page 22 is itself personalized, at least in part, by personalization system 54 (as referred to in step 78 in FIG. 4).

As indicated above, exploration page 22 is defined to implement product exploration metaphor technology. Product exploration metaphor systems are known in the e-commerce art. They permit users (customers) to explore a product space using product attributes. In such systems a defined set of product attributes are available for presentation to a customer. The customer is able to specify desired values for the presented product attributes and the exploration metaphor system will consequently display a subset of products that meet the criteria specified by the values input by the customer for the presented product attributes. An example system used to implement such an approach is shown as product exploration system 60 in FIG. 3. Product exploration system 60 defines a set of product attribute elements that are available for display to customers to permit customers to carry out the exploration of the product space.

In an exploration page, such as exploration page 22 shown in FIG. 2, product attribute elements are displayed to the customer to permit the customer to select product attribute values that are of interest. Product exploration system 60 in the example of FIG. 3 permits a customer to specify attributes of interest and therefore the information about products available to the customer is able to be appropriately filtered or tailored by an e-commerce system. Those products meeting the attribute values specified by the customer may be displayed to the customer in preference to other products.

Personalization system 54 interacts with product exploration system 60 to provide enhanced presentation of content to a user of an e-commerce system.

Personalization system 54 provides certain preset values for the product attribute elements displayed in exploration page 22. As described above, personalization system 54 determines a set of product attribute values for the product attribute elements displayed on exploration page 22. These values are determined by personalization system 54 as being values appropriate for the current customer using the system, based on that customer's attributes. This set of product attribute values is passed to product exploration system 60 to allow that system to preset some of the product attribute values used when the exploration page 22 is displayed.

This allows the consumer to explore the products of interest with some attributes pre-specified based on the personalization system. Personalization system 54 constructs a link for display on a web page in association with appropriate messages. The link references product exploration system 60 and includes preset product attribute values. As an example, where product attribute presets are for products recommended for seniors, with a price under fifty dollars and with an overstock indicator (“OS”), the URL for the link has the form:

http://hostname/ . . . /ProductExploration?category=Senior&price<50&inventory=OS

When the consumer clicks on the link (one of links 14, 16, 18, 20 in the example of FIG. 2), exploration page 22 is displayed with category, price, and inventory pre-specified as indicated. In this manner, the personalization approach is combined with the product exploration approach to provide an improved system for the consumer.

As set out above, product exploration system 60 defines certain product attribute elements that are potentially displayed to the consumer. Personalization system 54 also personalizes which of these product attribute elements are displayed to the consumer. For example, with reference to the above personalized link, the pre-specified inventory attribute may be hidden from the consumer (the appropriate product attribute element will not be displayed). This will be the case where the vendor does not wish to reveal to the consumer the fact that the item is overstocked nor to allow the shopper to change the pre-specified value of this attribute. In contrast, when the price attribute is displayed the consumer is free to change its value to see which products now meet this new price value.

In this way, the system provides the convenience of pre-selected values in the product attribute elements while permitting the consumer to use one or more of product attribute elements 24, 26, 28, and 30 to redefine those attribute values when appropriate. For example, personalized web page 10 has link 14 that relates to automobiles, exploration page 22 may predefine car attributes such as price and other vehicle options while permitting the consumer to select different attribute values where the preset values are not appropriate. Once these attributes are defined using one or more of product attribute elements 24, 26, 28, and 30, in the example of FIG. 2, the user may select show products button 32. This causes the system to select information that meets the criteria and to display that information to the user. In the example of FIG. 2, this is achieved by providing result page 34. This page contains product list 36 having information and links to product pages for products that meet the criteria. In a first embodiment example shown in FIG. 2, product list 36 includes product attribute table 37. Entries in product attribute table 37 include product attribute information and appropriate links to product pages that provide further information about products. The inclusion of product attribute information in product attribute table 37 permits a straightforward comparison of the values of the listed attributes for the different available products. A schematic example product page 38 is shown in the example of FIG. 2.

Using the automobile example referred to above, the user may use product attribute elements 24 and 26 to define a 2-door sedan with a cost above $50,000. After selecting (clicking on) show products button 32 the embodiment searches the information available and provides access to result page 34 showing product list 36 listing further links for vehicles that meet the criteria of the user. The user may follow one of these links in product list 36 to view information about a specific vehicle shown on product page 38. In addition, the product list is in a comparison table showing product attributes for the different products. This provides the consumer with a easily understood comparison between the products, based on attributes likely to be of interest to the consumer.

As will be appreciated by those skilled in the art, this arrangement of result page 34 and product page 38 is one of the available approaches to displaying the detailed information. Another of the possible designs for the display of the information is to have more detail available on result page 34 such that a further link to a product page 38 is unnecessary.

The approach of the first embodiment permits marketing content to be presented using a combination of personalization technology and product exploration technology.

Once a customer has chosen different attributes from those displayed on exploration page 22, the customer may select show products button 32 (see step 80 in FIG. 4). In the example shown in FIG. 2, result page 34 is displayed (corresponding generally to step 82 in the flow chart of FIG. 4). Result page 34 contains product list 36 having products relating to the criteria defined by the attributes selected by the customer in exploration page 22 (and with other, non-displayed attributes, as described above). This list may contain numerous product details or may contain summary details and links to more detailed pages. The example of FIG. 2 shows the latter arrangement. An item on product list 36 in FIG. 2 contains a link to product page 38 having more details about the product of interest.

In the system of the first embodiment, product list 36 is presented in a tabular format in which a short description of each product on the list is coupled with a link to a product page. The first embodiment is able to present products to the user in this convenient tabular format after the user has indicated product attributes of interest. Thus, the tabular presentation is expected to include only products in which the user is likely to be interested.

In each of the above implementations of the first embodiment of the invention, personalization technology is combined with technology utilizing a product exploration metaphor to provide a user with efficient and detailed access to information about products within the set that is initially recommended by the personalization system. A second embodiment is also described below. This second embodiment combines personalization technology with technology based on a guided search metaphor. In the guided search technology, prompts are provided to customers or users. The answers provided by the customer are used to reach other prompts and, eventually, web pages displaying marketing content. The structure of the guided search may be represented by a tree in which prompts are nodes in the tree, as are web pages displaying marketing content. In the second embodiment, described in more detail below, the prompts themselves are provided by way of web pages displayed to the customer.

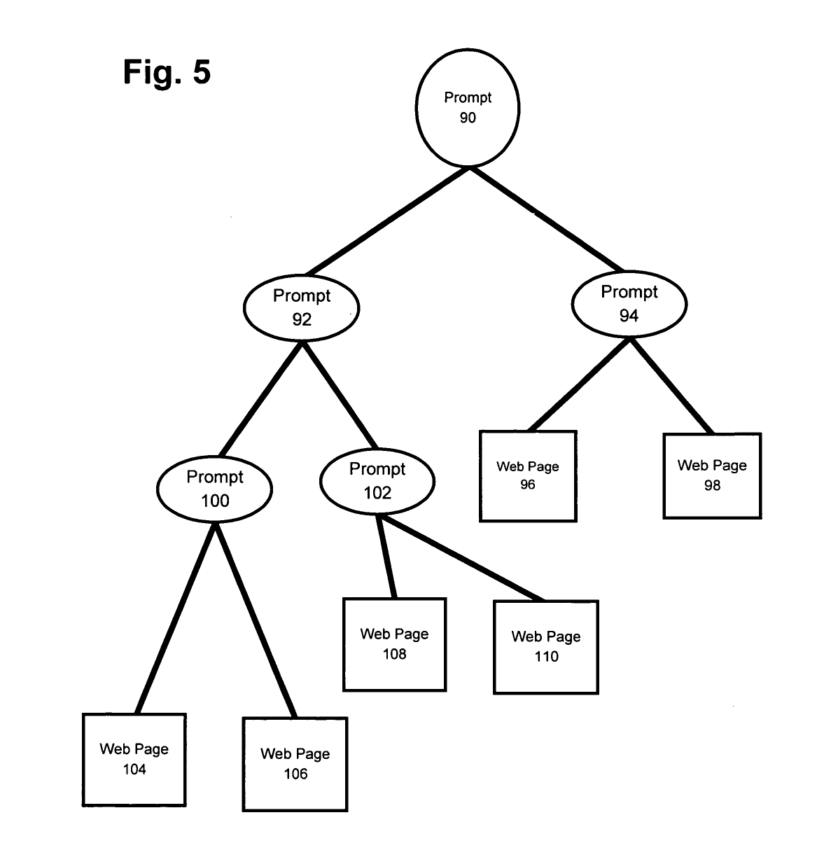

FIG. 5 is a tree diagram showing schematic representations of logical relationships between different web pages that are potentially displayed to a user in an example system of the second embodiment. An initial web page that prompts for user information is shown as prompt 90 in FIG. 5. This initial web page is, in the example of FIG. 5, the entry point for a set of web pages that define a guided search for a user. The response received from a user causes the system of the second embodiment to make available one of either prompt 92 or prompt 94. Similarly, information provided from a user in response to prompt 94 causes one of either web pages 96 or 98 to be displayed to the customer. In this way, the marketing content of interest to the consumer is displayed. In the guided search technology, such as that shown by example in FIG. 5, marketing content is presented to a user (consumer) based on the user's response to prompts (questions). The system implementing the guided search technology resolves the user's response into a set of product attributes that are, in turn, used to influence the scope for the search.

FIG. 5 illustrates the manner in which a guided search is facilitated by the system of the second embodiment. Initial web pages, represented as prompts 90, 92, and 94, prompt for and obtain information from a user that guides the user to either further prompting web pages (for example, web pages 92, 94), or to web pages containing content (for example web pages 96, 98). Other, more complex, examples may mix web pages that prompt for user information with web pages that present content to the user. It will also be understood that the simple binary tree shown in the example of FIG. 5 provides ease of presentation of the second embodiment and that in practice the tree structure representing an implementation of the system will likely be much more complex.

In the example of FIG. 5, prompt 92 is shown with dependent nodes in the tree corresponding to prompts 100 and 102. These in turn have dependent nodes comprising web pages 104 and 106 (dependent on prompt 100) and web pages 108 and 110 (dependent on prompt 102). As is described above, each of the nodes in the tree diagram of FIG. 5 represents a web page displayable to a user. The maximum number of prompt pages actually displayed in a given search is typically determined by how far down the tree the search proceeds (in the simple example of FIG. 5, one page may be displayed per level in the tree). In the second embodiment, certain prompts are effectively skipped as a result of information being made available by the personalization system.

In the second embodiment, the logic defining the display of the prompt node web pages accesses a personalization system or information derived from a personalization system. The guided search is utilized to further refine the results available from the personalization system. The guided search system that is implemented uses a subset of the defined guided search question/answer tree (represented in the example of FIG. 5). This subset is based on a set of product attributes made available from the personalization system. The tree is effectively pruned to a subset of the full tree by reference to product attributes made available by the personalization system.

For example, in FIG. 5, prompt 92 may seek confirmation of a particular user attribute before selecting to display one of the two prompting web pages shown as prompts 100 and 102. The attribute may be, for the sake of illustration, whether the user is a car owner. The web page for prompt 92 could contain a prompt seeking to elicit an answer to the question “do you own a car?” The guided search system logic will resolve the response to a product attribute corresponding to the answer provided to the prompt. For example, the user attribute “car owner” may resolve to the product attribute “heavy tent” when the guided search presents marketing content relating to camping equipment. Where a prompt is seeking information that will resolve to a product attribute that is already determined by the personalization system, that prompt is redundant and the system will skip the node in the tree that relates to that prompt (in this way effectively pruning the question/answer tree of the guided search). In the above example, the product attribute “heavy tent” may be already determined and made available from the personalization system. The personalization system may, for example, derive the product attribute “heavy tent” from the fact that the user has bought other heavy camping equipment in the past. In such a situation, even though the system has no knowledge of whether the user is a car owner, prompt 92 is not used by the guided search as the underlying product attribute (“heavy tent”) is determined by the personalization system.

Instead, the system of the second embodiment will choose to traverse the tree of FIG. 5 by using the information made available in the personalization system to select one of the nodes prompt 100 or 102. In other words, the guided search tree will be traversed using product attribute information made available by the personalization system, where possible.

As will be apparent, combining the personalization system with the guided search system gives a system that presents information to the user that is more useful than is the case with the personalization system alone. The set of recommendations otherwise obtainable by the personalization system is presented in a manner that is potentially more directly of use by the consumer. The guided search component of the system is itself enhanced by the availability of product attribute information from the personalization technology implemented in the system. Rather than the user expressly answering prompts to move through the guided search system, the system traverses certain portions of the tree based on information about the products likely to be of interest, the information having been made available by the personalization system.

The second embodiment may be designed such that personalization information of interest will be passed to the guided search technology portion of the system when that portion of the system commences execution. Referring again to FIG. 1, when one of links 14, 16, 18, or 20 in personalized web page 10 are followed to reach a guided search page (one of pages 21a, 21b, 21c, or 21d, respectively), information available about the user that is relevant to the guided search associated with those guided search pages will be passed to the application that implements the guided search technology for the appropriate page.

As may be seen from the above description of the two embodiments, the systems and methods for each embodiment rely on a personalized web page with personalized links referencing exploration or guided search pages relevant to the personalized links and in which the appropriate product exploration technology or guided search technology makes use of information available from the personalization system. In this way, the marketing content that the e-commerce system presents to a customer or user is tailored for that particular customer or user. For the customer or user, the marketing content is more efficiently presented.

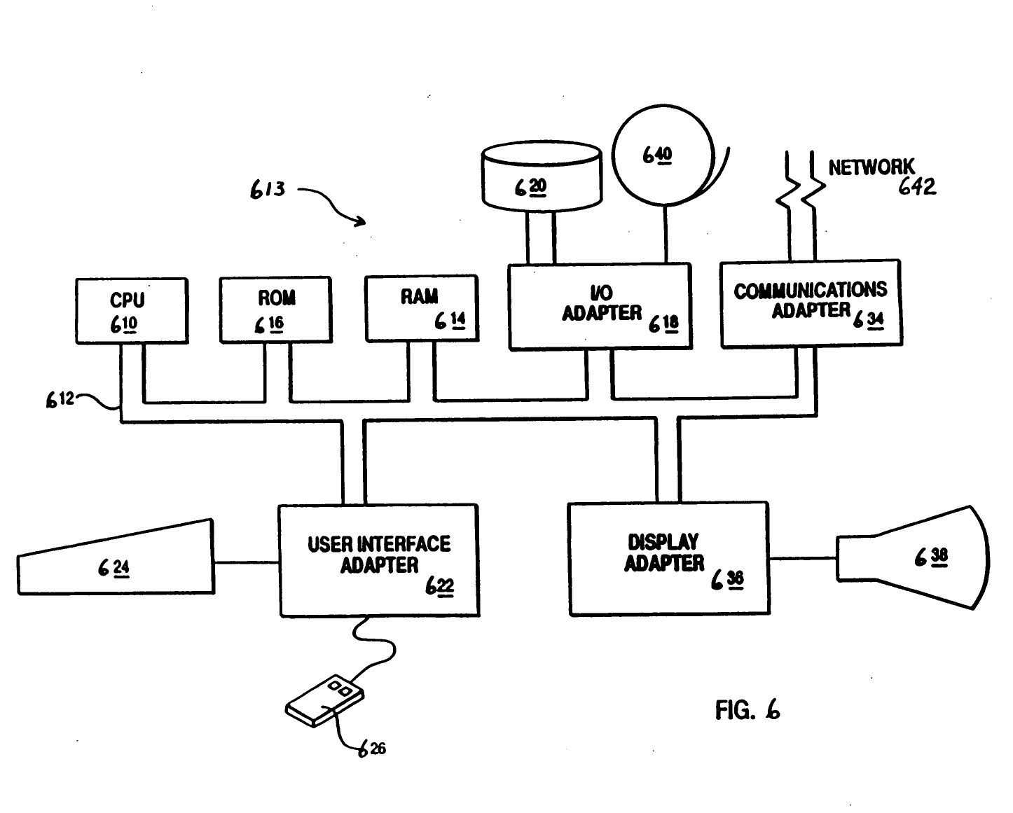

Referring to FIG. 6, an example is shown of a data processing system 613 which may be used for the present invention. The system has a central processing unit (CPU) 610, which is coupled to various other components by system bus 612. Read only memory (“ROM”) 616 is coupled to the system bus 612 and includes a basic input/output system (“BIOS”) that controls certain basic functions of the data processing system 613. Random access memory (“RAM”) 614, Input/Output (“I/O”) adapter 618, and communications adapter 634 are also coupled to the system bus 612. I/O adapter 618 may be a small computer system interface (“SCSI”) adapter that communicates with peripheral devices such as disk storage device 620 and tape drive 640. Communications adapter 634 interconnects bus 612 with an outside network 642 enabling the data processing system to communicate with other such systems. Input/Output devices are also connected to system bus 612 via user interface adapter 622 and display adapter 636. Keyboard 624, mouse 626, and other user interface devices such as a trackball and speaker (not shown) are all interconnected to bus 612 via user interface adapter 622. Display monitor 638 is connected to system bus 612 by display adapter 636. In this manner, a user is capable of inputting to the system through the keyboard 624, mouse 626, or trackball and receiving output from the system via speaker and display 638.

Implementations of the present invention include implementations as a computer system programmed to execute the method or methods described herein, and as a computer program product. According to the computer system implementation, sets of instructions for executing the method or methods may be resident in the random access memory 614 of one or more computer systems configured generally as described above. Until required by the computer system, the set of instructions may be stored as a computer program product in another computer memory, for example, in disk drive 620 (which may include a removable memory such as an optical disk or floppy disk for eventual use in the disk drive 620). Further, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the present invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, subsitutions and alterations can be made herein without departing from the spirit and scope of the invention as defined by the appended claims.

What is claimed is:

1. A computer program product for providing web-based electronic commerce personalized marketing content to a user, the computer program product comprising a computer usable medium having computer readable program code embodied in said medium, and comprising:
computer readable program code for defining a personalized web page comprising one or more links to initial product exploration or guided search web pages, the links being based on personalization information for the user;
computer readable program code for defining the one or more initial product exploration or guided search web pages, each initial product exploration or guided search web page being determined based on personalization information for the user,
each initial product exploration web page comprising an entry point to a set of exploration web pages defined according to product exploration metaphor technology and the set of said exploration web pages being defined with reference to personalization information for the user, and
each initial guided search web page comprising an entry point to a set of guided search web pages defined according to guided search technology and the set of said guided search web pages being defined with reference to personalization information for the user; and
computer readable program code for providing the defined web pages to the user for display.

2. The computer program product of claim 1 in which the personalization information for the user comprises a set of item attributes defined by a personalization system.

3. The computer program product of claim 2 in which each initial product exploration web page comprises a link to a result page.

4. The computer program product of claim 3 in which the result page comprises a result list.

5. The computer program product of claim 4 in which the result list comprises an item attribute table in which attributes of a set of items are grouped to permit comparison by a user.

6. The computer program product of claim 2 in which the set of guided search web pages comprises web pages corresponding to a subset of potential guided search nodes in a guided search tree, the subset being defined with reference to the personalization information for the user.

7. A web-based electronic commerce system for providing personalized marketing content to a user, the system comprising:
means for defining a personalized web page comprising one or more links to initial product exploration or guided search web pages, the links being based on personalization information for the user;
means for defining the one or more initial product exploration or guided search web pages, each initial product exploration or guided search web page being determined based on personalization information for the user,
each initial product exploration web page comprising an entry point to a set of exploration web pages defined according to product exploration metaphor technology and the set of said exploration web pages being defined with reference to personalization information for the user, and
each initial guided search web page comprising an entry point to a set of guided search web pages defined according to guided search technology and the set of said guided search web pages being defined with reference to personalization information for the user; and
means for providing the defined web pages to the user for display.

8. The system of claim 7 in which the personalization information for the user comprises a set of item attributes defined by a personalization system.

9. The system of claim 8 in which each initial product exploration web page comprises a link to a result page.

10. The system of claim 9 in which the result page comprises a result list.

11. The system of claim 10 in which the result list comprises an item attribute table in which attributes of a set of items are grouped to permit comparison by a user.

12. The system of claim 8 in which the set of guided search web pages comprises web pages corresponding to a subset of potential guided search nodes in a guided search tree, the subset being defined with reference to the personalization information for the user.

13. A computer-implemented method for providing web-based electronic commerce personalized marketing content to a user, the method comprising the steps of:
defining a personalized web page comprising one or more links to initial product exploration or guided search web pages, the links being based on personalization information for the user;
defining the one or more initial product exploration or guided search web pages, each initial product exploration or guided search web page being determined based on personalization information for the user,
each initial product exploration web page comprising an entry point to a set of exploration web pages defined according to product exploration metaphor technology and the set of said exploration web pages being defined with reference to personalization information for the user, and
each initial guided search web page comprising an entry point to a set of guided search web pages defined according to guided search technology and the set of said guided search web pages being defined with reference to personalization information for the user; and
providing the defined web pages to the user for display in response to requests from the user.

14. The method of claim 13 in which the personalization information for the user comprises a set of item attributes defined by a personalization system.

15. The method of claim 14 in which each initial product exploration web page comprises a link to a result page.

16. The method of claim 15 in which the result page comprises a result list.

17. The method of claim 16 in which the result list comprises an item attribute table in which attributes of a set of items are grouped to permit comparison by a user.

18. The method of claim 14 in which the set of guided search web pages comprises web pages corresponding to a subset of potential guided search nodes in a guided search tree, the subset being defined with reference to the personalization information for the user.
